(19) United States
(12) Patent Application Publication
(10) Pub. No.: US 2023/0129197 A1
(43) Pub. Date: Apr. 27, 2023

(54) Kitty Cure Wrap

(71) Applicants: Alan Dale Kacic, Tucson, AZ (US); Tyler Alan Kacic, Tucson, AZ (US); Nicholas Kacic, Tucson, AZ (US); Regis Wiegand, Tucson, AZ (US); Rosita Campbell, Tucson, AZ (US)

(72) Inventors: Alan Dale Kacic, Tucson, AZ (US); Tyler Alan Kacic, Tucson, AZ (US); Nicholas Kacic, Tucson, AZ (US); Regis Wiegand, Tucson, AZ (US); Rosita Campbell, Tucson, AZ (US)

(21) Appl. No.: 18/048,791

(22) Filed: Oct. 21, 2022

Related U.S. Application Data
(60) Provisional application No. 63/270,195, filed on Oct. 21, 2021.

(51) Int. Cl. A01K 15/02

(52) U.S. Cl. CPC A01K 15/024

(57) ABSTRACT

A scratching pad comprising a base, a filing sheet, and a cover. The filing sheet is arranged against the base and the cover is arranged against the filing sheet, opposite the base. The base is a protective, non-porous material. The filing sheet further comprises an abrasive surface configured to dull sharp objects that rub against it. The cover is made of a porous material configured to allow sharp objects to pass through it. The scratching pad and its components are all flexible as to allow the scratching pad to be manipulated and wrapped around external objects.

### FIELD OF THE INVENTION

The present invention relates generally to scratching pads for cat claws. More specifically, the present invention relates to abrasive scratching surfaces that can be wrapped onto or attached to other surfaces.

### BACKGROUND OF THE INVENTION

Many individuals across the globe keep animals at pet companions. Cats are a very popular option amongst many people as an animal to keep for a pet. With owning a cat comes various responsibilities to properly take care of the animal and ensure the surrounding environment stays protected and safe. Many cats have razor sharp claws that can be used to damage furniture when the cat scratches around and can potentially cause harm to any nearby humans if the claws come in contact with exposed skin. Currently owners attempt to mitigate this damage and potential harm by either clipping and filing down the claws of the cat or by declawing the cat. Filing or clipping the claws of a cat requires multiple sessions to keep the nails short taking away time from the owner. Additionally, declawing a cat requires a large upfront cost for the owner and can potentially be done incorrectly, injuring the cat in the process.

Scratching posts and other scratching surfaces currently exist. However, many of these products merely allow a cat to satisfy its urge to scratch without actually addressing the problem of dulling the claws. Further, many of these products wear down easily and require replacing an entire scratching post or wall on a regular basis. The present invention provides users with a durable and abrasive material wrap that can be placed on any object, remedying the shortcomings of similar products.

### SUMMARY OF THE INVENTION

The present invention is an animal scratching apparatus to help with reducing the sharpness of cat claws to limit damage to furniture and lower the risk of harm to exposed skin of people. The present invention seeks to provide users with a device that can placed on various surfaces around the house to encourage cat interaction. In order to accomplish this the present invention comprises a base that is made of a soft, durable, and non-porous material to provide a soft contact with the furniture. Further, the present invention comprises a filing sheet is designed to safely and efficiently dull the claws of the cat. Additionally, the invention comprises a cover that is placed over the present invention to attract the cat and encourage interaction, while allowing claws to interact with the filing sheet underneath. Further, the present invention includes at least one fastener designed to allow the present invention to be wrapped securely around objects or hung on objects or vertical surfaces. Thus, the present invention is a material wrap that can be placed on any surface with a cover material to encourage the cat to interact with the present invention, thus safely and efficiently filing down the sharp claws of the cat during the interaction.

### BRIEF DESCRIPTION OF THE DRAWINGS

FIG. 1 is a top perspective view of the present invention wrapped around a standard scratching post in accordance with at least one embodiment.

FIG. 2 is a bottom perspective view of the present invention wrapped around a standard scratching post in accordance with at least one embodiment.

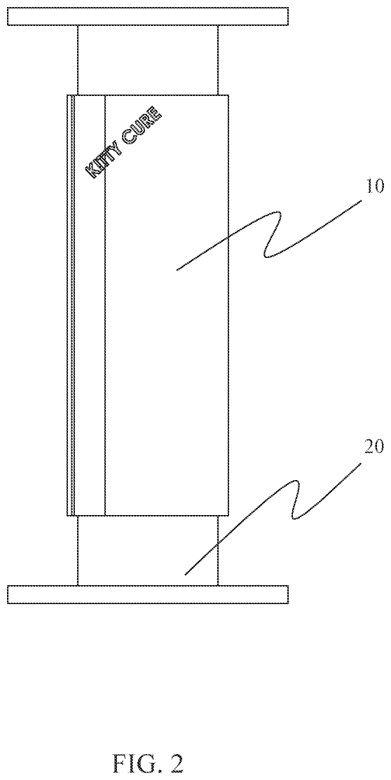

FIG. 3 is a front view of the present invention wrapped around a standard scratching post in accordance with at least one embodiment.

FIG. 4 is a perspective view of the present invention in accordance with at least one embodiment.

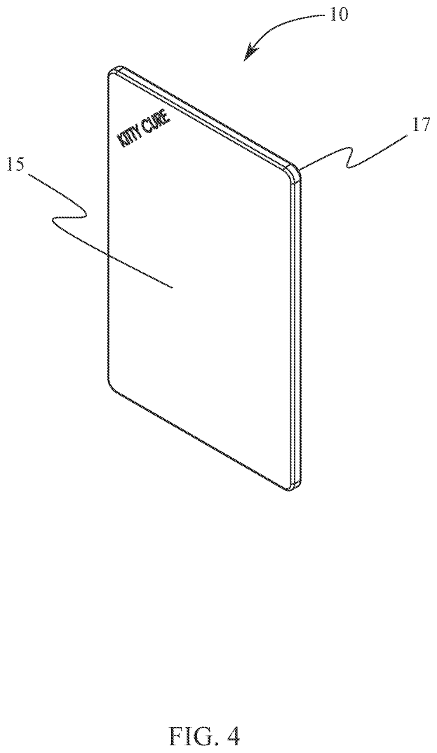

FIG. 5 is a front view of the present invention in accordance with at least one embodiment.

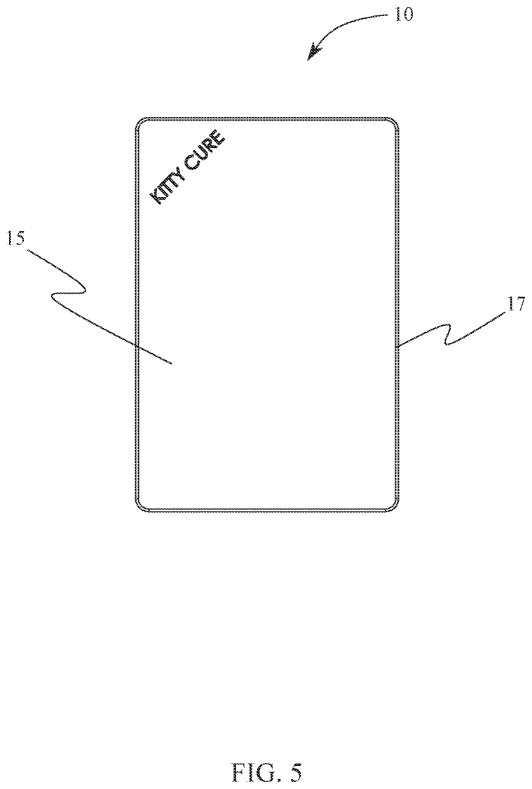

FIG. 6 is a perspective view of the present invention attached to a vertical surface in accordance with at least one embodiment.

FIG. 7 is a front view of the present invention attached to a vertical surface in accordance with at least one embodiment.

FIG. 8 is a front perspective view of the present invention in accordance with at least one embodiment.

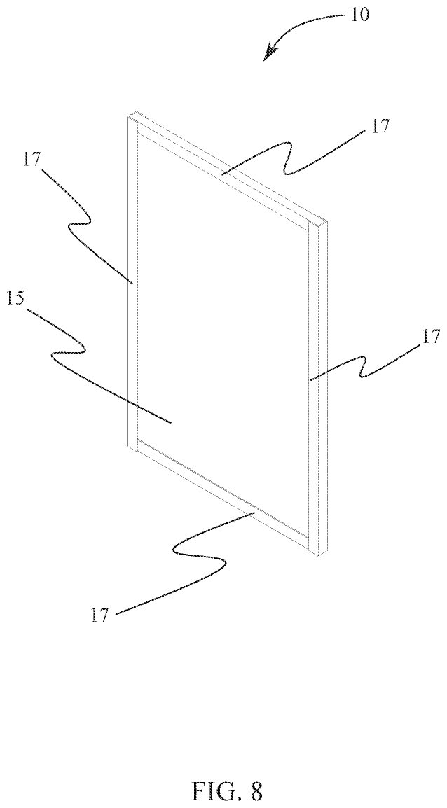

FIG. 9 is a rear perspective view of the present invention in accordance with at least one embodiment.

FIG. 10 is an exploded perspective view of the present invention in accordance with at least one embodiment.

### DETAIL DESCRIPTIONS OF THE INVENTION

All illustrations of the drawings are for the purpose of describing selected versions of the present invention and are not intended to limit the scope of the present invention.

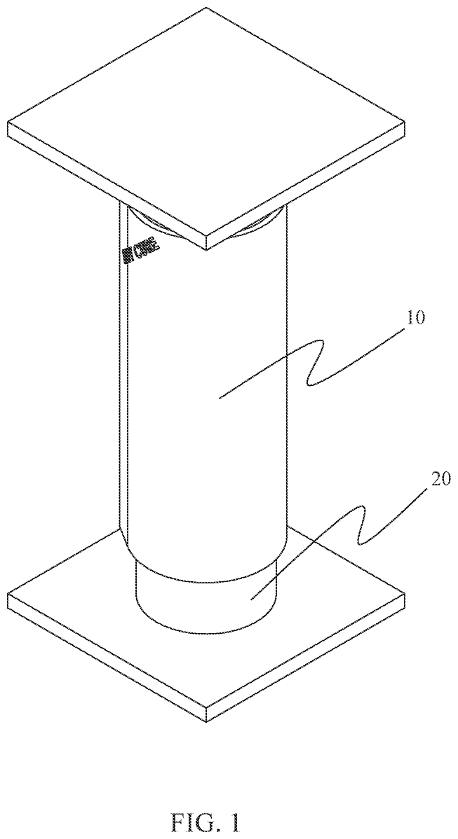

As shown in FIG. 1, the scratching pad 10 of the present invention is a material wrap that can be placed on any object within a household. An objective of the present invention is to provide users with wrap that encourages cats to interact and file down their sharp claws. The present invention intends to provide users with a device that utilizes an abrasive material to ensure the claws of the cat are dulled down. To accomplish this the present invention comprises a base 11, a filing sheet 13, a cover 15, and at least one fastener 19. Many of these components allow for the cat to be attracted to the present invention and interact with it in order to file down their sharp claws.

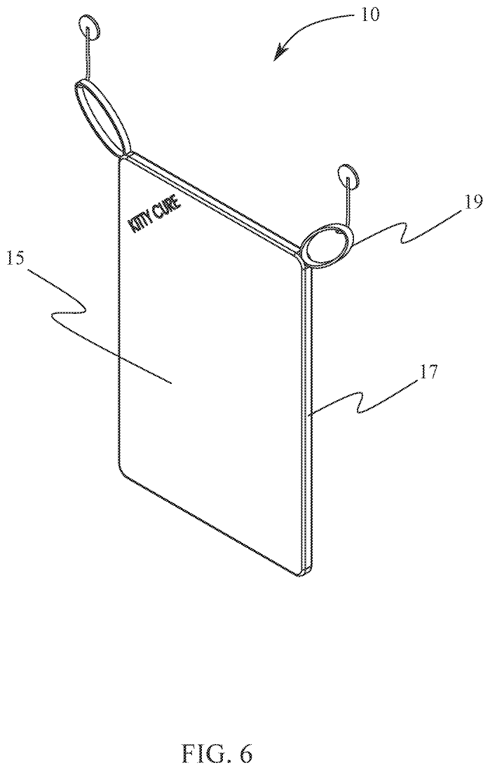

As shown in FIG. 1, the scratching pad 10 may be wrapped around a post 20 or similar surface, creating an upright scratching surface. Similarly, as shown in FIG. 6, the scratching pad 10 may be hung on a wall or other vertical surface as an alternative way of creating an upright scratching surface. The present invention is not limited to these two configurations.

The base 11 of the present invention is preferably a soft, protective, non-porous material such as cotton, configured to provide a barrier between the present invention and the surface to which it is connected. The base 11 protects the surface to which the scratching pad 10 is connected from being damaged by the filing sheet 13 or the cat using the scratching pad 10. The filing sheet 13 comprises an abrasive surface 131 configured to dull claws or similar sharp objects that rub against the filing sheet 13. In the preferred embodiment, the abrasive surface 131 is an aluminum oxide micro grit surface. The filing sheet 13 preferably has the abrasive surface 131 on one side with a smooth surface 133 on the opposite side, though an embodiment may include the abrasive surface 131 on both sides of the filing sheet 13. The cover 15 is preferably a porous, durable fabric material. The cover 15 is configured allow claws to penetrate through it when scratched without substantially damaging the structural integrity of the cover 15. Additionally, the material used for the cover 15 is designed to attract cats. In the preferred embodiment, the cover 15 is made of burlap, which may attract a cat through the look and feel, though other attraction methods such as smell may also be used. The base 11, filing sheet 13, and cover 15 of the present invention are all flexible, allowing for the scratching pad 10 to be wrapped around surfaces.

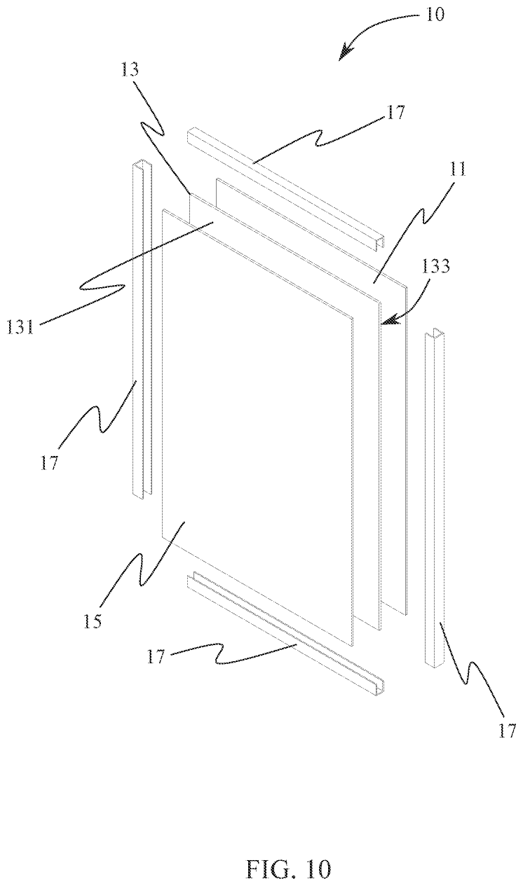

As shown in FIG. 10, the base 11 of the scratching pad 10 is positioned adjacent to the filing sheet 13. In embodiments with the filing sheet 13 having an abrasive surface 131 and a smooth surface 133, the smooth surface 133 is arranged against the base 11. The cover 15 is positioned adjacent to the filing sheet 13, opposite the base 11. Specifically, the cover 15 is arranged against the abrasive surface 131 of the filing sheet 13. A trim 17 may be used to hold the base 11, filing sheet 13, and cover 15 together and in place. The trim 17 perimetrically surrounds the base 11, filing sheet 13, and cover 15, leaving a majority of the surface of the cover 15 accessible and uncovered. In the preferred embodiment, the trim 17 is a fabric material similar to that of the base 11 and the trim 17 is sewn into the edges of the base 11, filing sheet 13, and cover 15 to prevent movement of the components relative to one another and prevent damage to surrounding objects. It should be further noted that, the base 11 can be created in many various shapes and sizes and the plurality of threaded edges could positioned in various ways while still staying within the scope of the present invention.

In its preferred embodiment, the filing sheet 13 is designed with 320-aluminum oxide micro grit with a rectangular shape similar to the shape of the base 11. The filing sheet 13 material is designed be flexible to allow the present invention to be folded to wrap around any shaped object while still providing a hard surface that will properly file down the razor-sharp nails of the cat. Additionally, the 320-aluminum oxide micro grit provides the user with a material that is nontoxic to cats and humans, is odorless, and does not produce any airborne particles as the claw is grinded upon the 320-aluminum oxide micro grit surface.

The cover 15 is designed with a similar shape and size as the base 11 and is secures on all four sides creating an inner area in which the filing sheet 13 rests. In its preferred embodiment the cover 15 comprises a design element. The design element is preferably positioned in the upper left side of the cover 15 and may spell out the word “KITTY CURE” as seen in FIG. 6 or show other words or logos. The cover 15 is designed with a burlap material that attracts and grabs the cat's attention causing the cat to swipe at the material. As the cat swipes at the cover 15 the claws of the cat can pass through sections of the burlap material, coming into contact with the abrasive surface 131 of the filing sheet 13. This allows the cat to swipe at the present invention and file their sharp claws down in an efficient manner.

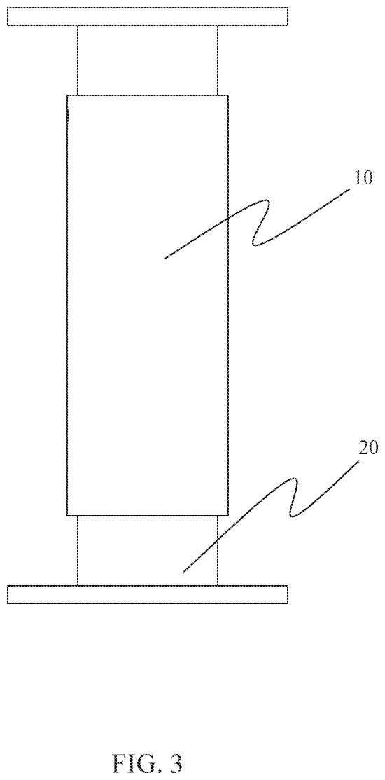

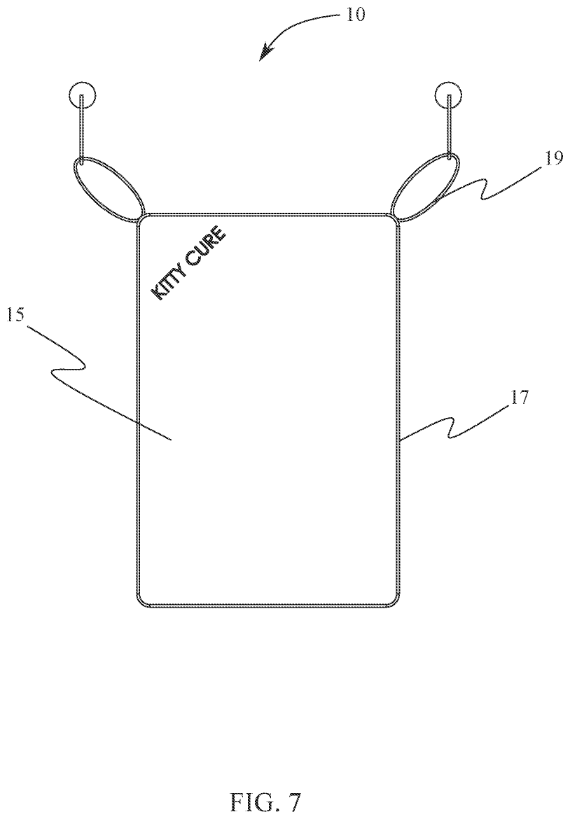

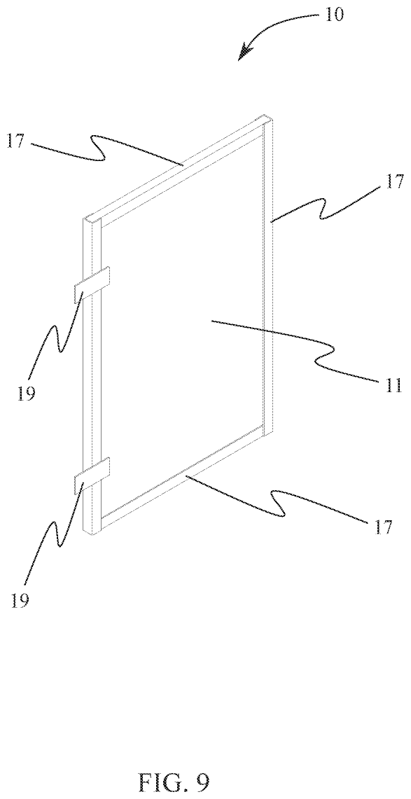

The at least one fastener 19 connects with the present invention by attaching to the base 11. In one embodiment, the at least one fastener 19 is designed as a double-sided adhesive strip that allows the present invention to be wrapped around an object like a cat scratching post 20 shown in FIG. 3. The at least one fastener 19 may be configured to connect one side of the scratching pad 10 to another side in a loop, as seen in FIG. 9, or arranged to attach at least one side of the scratching pad 10 to a surface as seen in FIG. 7. Furthermore, in an alternative embodiment the fastener 19 can be designed as a plurality buttons/snaps, alligator clips, hook and loop fasteners, or suction cups that allows the present invention to be secured to itself, various objects, and vertical surfaces.

As shown in FIG. 3, the preferred embodiment of the present invention includes the scratching pad 10 and a post 20. The scratching pad 10 is removably attached to the post 20 by wrapping the scratching pad 10 around the post 20 and securing the scratching pad 10 in place with the at least one fastener 19. The at least one fastener 19 may secure the scratching pad 10 to the post 20 either by attaching the scratching pad 10 to itself tightly enough to stay on the post 20 and/or by attaching the scratching pad 10 directly to the post 20. By being removably attachable to the post 20, the scratching pad 10 of the present invention may be swapped out when damaged, such as by the cover 15 being ripped apart or the abrasive surface 131 being worn down. This removable scratching pad 10 allows a post 20 to be continuously reused despite regular damage to the scratching pad 10 through general use.

With all the components working in tandem, it can be seen that the present invention is a scratching pad 10 that can be placed on any surface having a cover 15 to encourage a cat to interact with the scratching pad 10, and an abrasive surface 131 to safely and efficiently file down the sharp claws of the cat during interaction.

Although the invention has been explained in relation to its preferred embodiment, it is to be understood that many other possible modifications and variations can be made without departing from the spirit and scope of the invention.

What is claimed is:

1. An animal scratching apparatus, comprising:
a scratching pad, comprising:
a base;
a filing sheet;
a cover;
a trim;
the filing sheet further comprising an abrasive surface;
the base arranged adjacent to the filing sheet;
the cover arranged adjacent to the filing sheet, opposite the base;
the trim perimetrically surrounding the base, filing sheet, and cover; and
the cover being made of a porous material.

2. The animal scratching apparatus of claim 1, further comprising:
the filing sheet further comprising a smooth surface;
the smooth surface oppositely positioned on the filing sheet from the abrasive surface; and
the smooth surface arranged against the base.

3. The animal scratching apparatus of claim 1, further comprising:
a majority of the cover being uncovered by the trim; and
a majority of the base being uncovered by the trim.

4. The animal scratching apparatus of claim 1, wherein the cover is configured to allow sharp objects to pass through the cover.

5. The animal scratching apparatus of claim 1, wherein the abrasive surface is configured to dull sharp objects that rub against the abrasive surface.

6. The animal scratching apparatus of claim 5, wherein the abrasive surface is made up of aluminum oxide micro grit.

7. The animal scratching apparatus of claim 1, further comprising:
the scratching pad further comprising at least one fastener;
the at least one fastener connecting to the trim; and
the at least one fastener configured to connect the scratching pad to an external surface.

8. The animal scratching apparatus of claim 7, further comprising:
a post;
the scratching pad being wrapped around the post; and
the scratching pad being connected to the post by the at least one fastener.

9. The animal scratching apparatus of claim 1, wherein the scratching pad is flexible.

10. An animal scratching apparatus, comprising:
a scratching pad, comprising:
a base;
a filing sheet;
a cover;
at least one fastener;
the filing sheet further comprising an abrasive surface
the base arranged adjacent to the filing sheet;
the cover arranged adjacent to the filing sheet, opposite the base;
the at least one fastener connecting to the trim;
the cover being made of a porous material configured to allow sharp objects to pass through the cover;
the abrasive surface being made up of aluminum oxide micro grit, configured to dull sharp objects that rub against the abrasive surface; and
the at least one fastener configured to connect the scratching pad to an external surface.

11. The animal scratching apparatus of claim 10, wherein the scratching pad is flexible.

12. The animal scratching apparatus of claim 10, further comprising:
the filing sheet further comprising a smooth surface;
the smooth surface oppositely positioned on the filing sheet from the abrasive surface; and
the smooth surface arranged against the base.

13. The animal scratching apparatus of claim 10, further comprising:
the scratching pad further comprising a trim;
the trim perimetrically surrounding the based, filing sheet, and cover;
a majority of the cover being uncovered by the trim; and
a majority of the base being uncovered by the trim.

14. An animal scratching surface, comprising:
a scratching pad;
a post;
the scratching pad comprising:
a base
a filing sheet,
a cover,
the base arranged adjacent to the filing sheet;
the cover arranged adjacent to the filing sheet, opposite the base; and
the filing sheet further comprising an abrasive surface;
the scratching pad being flexible; and
the scratching pad being wrapped around the post.

15. The animal scratching surface of claim 14, further comprising:
the filing sheet further comprising a smooth surface;
the smooth surface oppositely positioned on the filing sheet from the abrasive surface; and
the smooth surface arranged against the base.

16. The animal scratching surface of claim 14, further comprising:
the scratching pad further comprising a trim;
the trim perimetrically surrounding the base, filing sheet, and cover;
a majority of the cover being uncovered by the trim; and
a majority of the base being uncovered by the trim.

17. The animal scratching surface of claim 14, further comprising:
the cover being made of a porous material configured to allow sharp objects to pass through the cover; and
the abrasive surface being made up of aluminum oxide micro grit, configured to dull sharp objects that rub against the abrasive surface.

18. The animal scratching surface of claim 14, further comprising:
the scratching pad further comprising at least one fastener;
the at least one fastener connecting to the trim; and
the at least one fastener configured to connect the scratching pad to an external surface; and
the scratching pad being connected to the post by the at least one fastener.
